(19) United States
(12) Patent Application Publication
(10) Pub. No.: US 2021/0316502 A1
(43) Pub. Date: Oct. 14, 2021

(54) High Throughput Additive Manufacturing System Supporting Absorption Of Amplified Spontaneous Emission In Laser Amplifiers

(71) Applicant: Seurat Technologies, Inc., Mountain View, CA (US)

(72) Inventors: Andrew J. Bayramian, Marblehead, MA (US); James A. DeMuth, Woburn, MA (US)

(21) Appl. No.: 17/225,977

(22) Filed: Apr. 8, 2021

Related U.S. Application Data
(60) Provisional application No. 63/008,466, filed on Apr. 10, 2020.

(51) Int. Cl. B29C 64/153; B33Y 10/00; B22F 10/28; B33Y 30/00; B23K 26/146; B22F 12/42; B29C 64/268; B22F 12/20

(52) U.S. Cl. CPC B29C 64/153; B33Y 10/00; B22F 10/28; B22F 12/20; B23K 26/146; B22F 12/42; B29C 64/268; B33Y 30/00

(57) ABSTRACT

In one embodiment a manufacturing method involves generating laser light at a first wavelength or range of wavelengths. A laser amplifier having a gain medium that amplifies light at a second wavelength or range of wavelengths can be optically pumped in response to receiving the generated laser light. The gain medium is cooled with a coolant fluid able to absorb the second wavelength or range of wavelengths and the generated and amplified laser light is directed toward an article processing unit.

### CROSS -REFERENCE TO RELATED PATENT APPLICATION

The present disclosure is part of a non-provisional patent application claiming the priority benefit of U.S. Patent Application No. 63/008,466, filed on Apr. 10, 2020, which is incorporated by reference in its entirety.

### TECHNICAL FIELD

The present disclosure generally relates to a system and method for high throughput additive manufacturing. In one embodiment powder bed fusion manufacturing is supported by cooled high power laser amplifiers and, more particularly, to fluid cooling systems able to absorb amplified spontaneous emission (ASE) of laser light.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known as powder bed fusion (PBF) uses one or more focused energy sources, such as a laser or electron beam, to draw a pattern in a thin layer of powder by melting the powder and bonding it to the layer below. Powders can be plastic, metal or ceramic. This technique is highly accurate and can typically achieve feature sizes as small as 150-300 um. However, powder bed fusion additive manufacturing machine manufacturers struggle to create machines that can produce printed material in excess of 1 kg/hr. Because of this slow powder-to-solid conversion rate, machine sizes are relatively small due to the length of time it would take to print larger parts. Today's largest machines have printable part volumes generally less than 64 L (40 cm)3. While these printers are capable of printing parts of nearly arbitrary geometry, due to the high machine cost and low powder conversion rate the amortized cost of the machine ends up being very high, resulting in expensive parts.

Increasing available energy from lasers could increase additive manufacturing throughput and reduce costs. This can be accomplished using high power laser amplifiers to provide or store energy for a laser system, as well as allow for aperture scaling to avoid laser damage of the substrate and/or optical coatings. However, as amplifier size increases, problems associated with unwanted lasing phenomenon such as amplified spontaneous emission (ASE) can occur. ASE occurs when spontaneously emitted photons traverse a laser gain medium and are amplified before they exit the gain medium in a transverse direction (i.e. a direction along which the laser beam does not propagate). ASE is favored when there is a combination of high gain and a long path for the spontaneously emitted photons. In effect, ASE depopulates the upper energy level in an excited laser gain medium and robs the laser of its power. Furthermore, reflection of ASE photons at gain medium boundaries may provide feedback for parasitic oscillations that further increase loss of laser power. In certain situations, ASE may even become large enough to deplete the upper level inversion in high-gain laser amplifiers.

To reduce ASE associated issues, a common practice is to have a material which absorbs at the ASE laser wavelength mounted on all sides of the gain medium where the laser does not have to transmit. This material is often referred to as edge-cladding or absorber-cladding. For example, a Nd laser operating around 1.06 micrometer wavelength can be clad with a material including divalent cobalt and divalent samarium ions.

In addition to problems with ASE or parasitic lasing, large amplifiers generate substantial waste heat. Unless removed, this waste heat can be deposited into the gain medium where it can be responsible for thermal lensing, mechanical stresses, depolarization, degradation of beam quality (BQ), loss of laser power, or thermal fracture. To reduce such heating problems, amplifiers have commonly been cooled using flow tubes that circulate a cooling gas or liquid around the amplifier gain medium. In some embodiments, the flow tube can be doped with ASE absorber ions to provide edge or absorber cladding functionality. However, as the average power of the amplifiers is increased, thermal loading on these flow tube edge/absorber cladding materials also increases, potentially resulting in thermal fracture. Since such ASE absorber flow tubes contain the coolant, flow tube fracture is catastrophic and can lead to destruction of the flashlamps, diode sources, or the amplifier gain medium (e.g. an amplifier rod). Systems that minimize ASE effects, while still allowing for easy cooling and replacement of the amplifier gain medium are needed.

### SUMMARY

In one embodiment a manufacturing method involves generating laser light at a first wavelength or range of wavelengths. A laser amplifier having a gain medium that amplifies light at a second wavelength or range of wavelengths can be optically pumped in response to receiving the generated laser light. The gain medium is cooled with a coolant fluid able to absorb the second wavelength or range of wavelengths and the generated and amplified laser light is directed toward an article processing unit.

In one embodiment, the gain medium is at least one of a rod amplifier and a slab amplifier.

In one embodiment of the manufacturing method, the gain medium is a slab amplifier.

In one embodiment of the manufacturing method, the gain medium is at least one of a Nd:YAG rod and a Nd:YLF rod.

In one embodiment of the manufacturing method, the coolant fluid comprises an aqueous salt solution.

In one embodiment of the manufacturing method, heat from the coolant fluid is processed by a rejected energy handling unit.

In one embodiment of the manufacturing method, directed amplified laser light is patterned as a two dimensional image.

In one embodiment of the manufacturing method, directed amplified laser light is patterned using a light valve.

In one embodiment of the manufacturing method, the article processing unit comprises an additive manufacturing build chamber.

In one embodiment of the manufacturing method, the article processing unit comprises an additive manufacturing build chamber that holds at least one of a metal, ceramic, plastic, glass metallic hybrid, ceramic hybrid, plastic hybrid, or glass hybrid material that can receive directed amplified laser light.

In one embodiment useful in a manufacturing assembly, a laser amplifier includes a light pump source that can generate light at a first wavelength or range of wavelengths. The laser amplifier further includes an optically pumped laser amplifier having a gain medium that amplifies light at a second wavelength or range of wavelengths in response to receiving generated light from the light pump source. A housing is used to at least partially surround the gain medium and hold a coolant fluid able to absorb the second wavelength or range of wavelengths.

In one embodiment useful in a manufacturing assembly, the gain medium is a rod amplifier.

In one embodiment useful in a manufacturing assembly, the gain medium is a slab amplifier.

In one embodiment useful in a manufacturing assembly, the gain medium is a Nd:YAG rod and the coolant fluid can absorb 1064 nm laser emission.

In one embodiment useful in a manufacturing assembly, the gain medium is a Nd:YLF rod and the coolant fluid can absorb at least one of 1047 or 1053 nm laser emission.

In one embodiment useful in a manufacturing assembly, the coolant fluid transmits light at a first wavelength or range of wavelengths from the light pump source.

In one embodiment useful in a manufacturing assembly, wherein the coolant fluid comprises an aqueous salt solution.

In one embodiment useful in a manufacturing assembly, the coolant fluid comprises an aqueous salt solution with at least one of samarium chloride, samarium nitrate, samarium sulfate, copper nitrate, copper sulfate, or copper chloride.

In one embodiment useful in a manufacturing assembly, the housing is a flow tube.

In one embodiment useful in a manufacturing assembly, the housing is a flow tube doped to absorb light at the second wavelength or range of wavelengths.

In one embodiment useful in a manufacturing assembly, the housing and the gain medium together define a cavity able to hold the coolant fluid.

In one embodiment useful in a manufacturing assembly, a laser amplifier includes a light pump source that can generate light at a first wavelength or range of wavelengths. An optically pumped laser amplifier having a gain medium that amplifies light at a second wavelength or range of wavelengths in response to receiving generated light from the light pump source is at least partially surrounded with a housing. The housing also at least partially surrounds the gain medium and holds a solid matrix that is able to absorb the second wavelength or range of wavelengths, with the solid matrix being cooled by a coolant fluid.

In one embodiment useful in a manufacturing assembly, the solid matrix defines a lattice structure doped with samarium or copper.

In one embodiment useful in a manufacturing assembly, the solid matrix comprises a bed of pebble shaped material doped with samarium or copper.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a laser amplifier with a flow tube and a contained light absorbing solution;

FIG. 1B illustrates a laser amplifier with a flow tube and a contained light absorbing structures;

FIG. 1C illustrates a slab amplifier with a flow cavity and additional cladding;

FIG. 1D illustrates a slab amplifier with a flow cavity and contained light absorbing structures; and

FIG. 1E illustrates a slab amplifier with additional cladding in a solid state configuration

FIG. 2 illustrates a laser system including a cooled amplifier; and

FIG. 3 illustrates a manufacturing assembly having a laser system including a cooled fluid amplifier.

FIG. 4 illustrates a manufacturing processing include rejected energy handling from a cooled amplifier; and

FIG. 5 illustrates a manufacturing assembly having a switchyard laser system including a cooled fluid amplifier.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

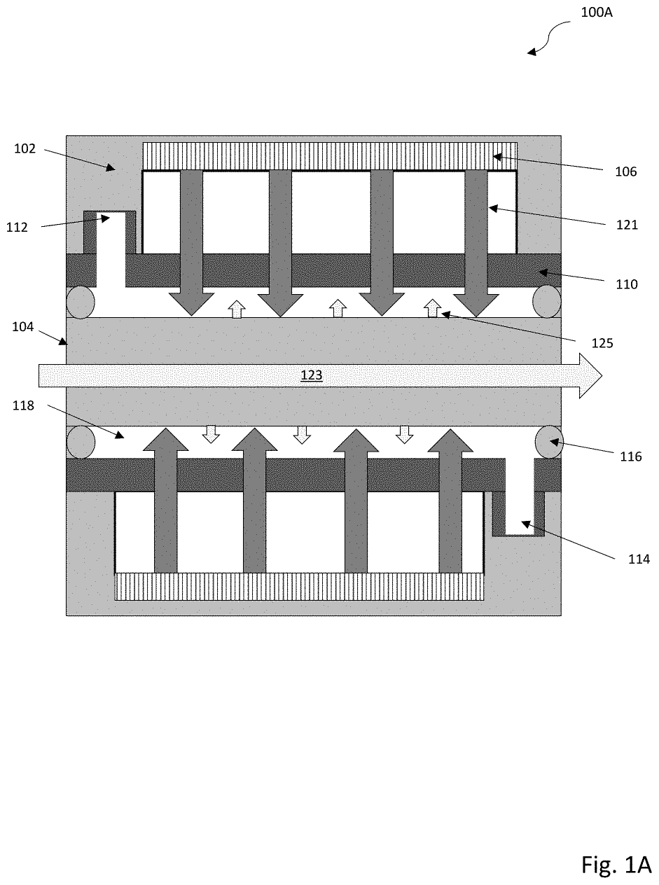

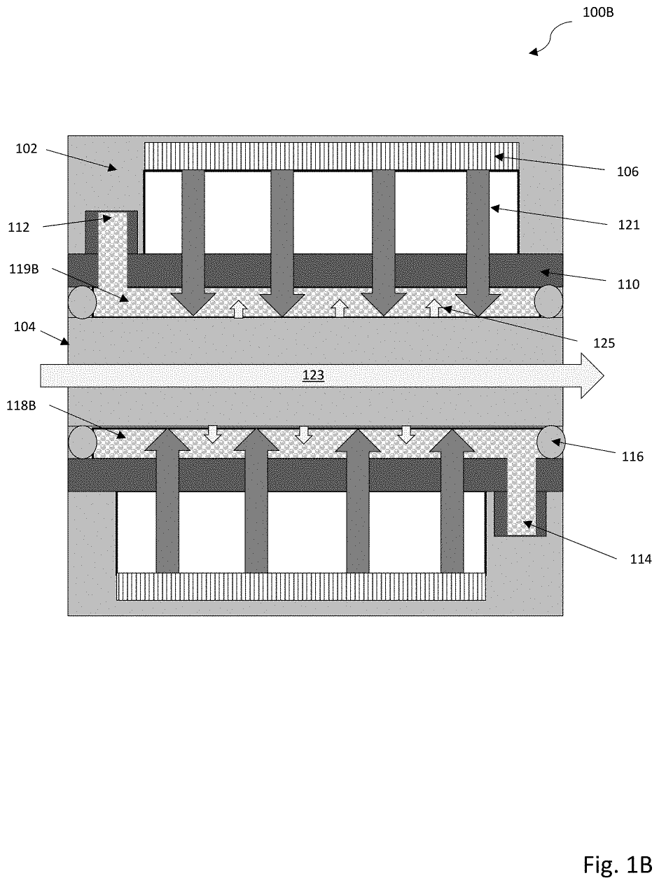

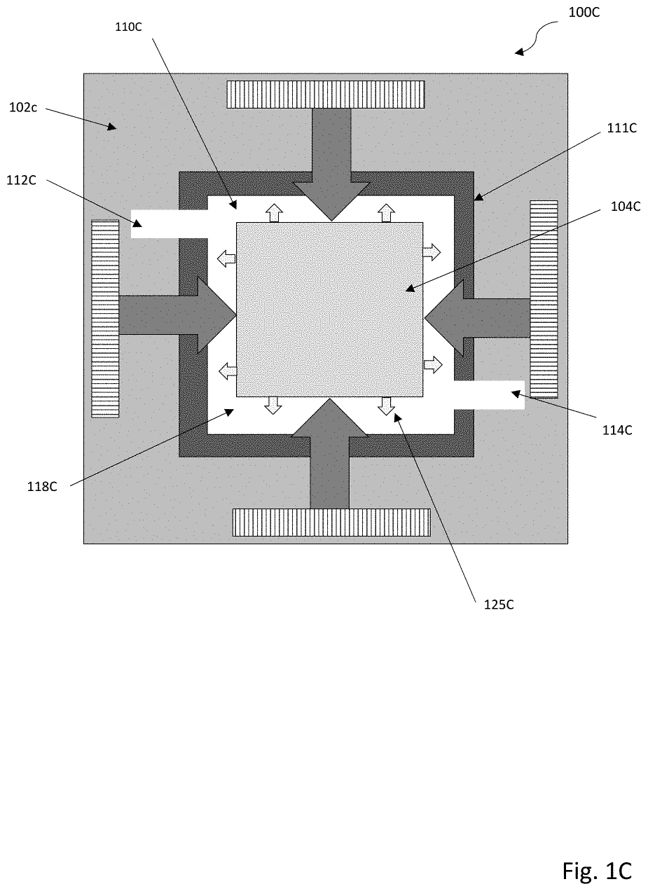

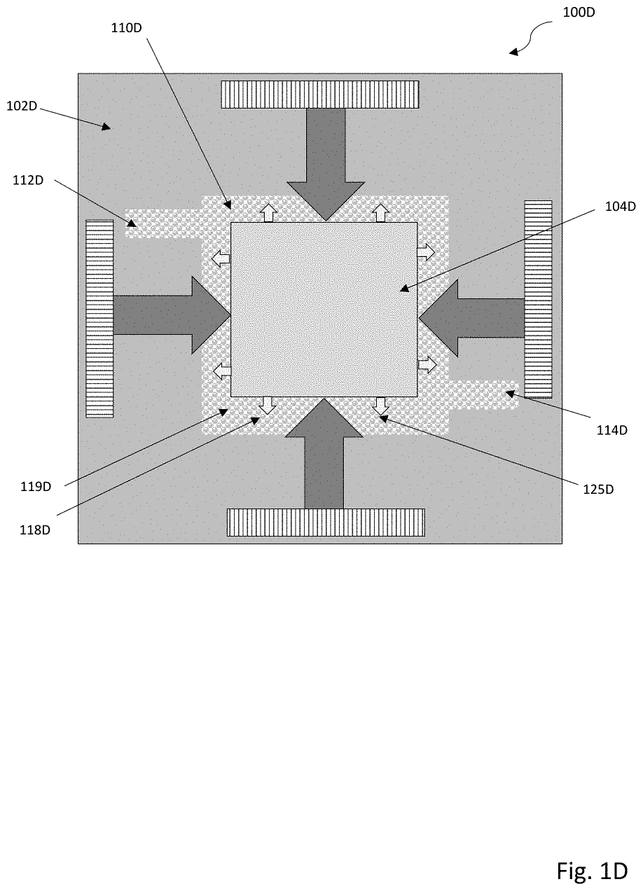

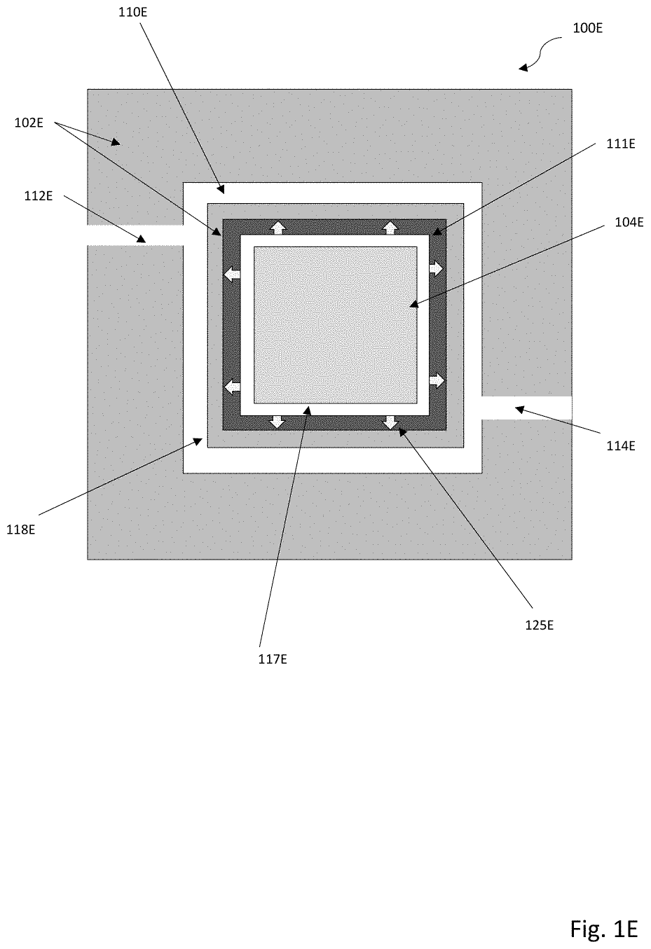

FIG. 1A illustrates a laser cooling system 100A for a rod amplifier in cross-sectional view. The system 100A includes an amplifier housing 102 that at least partially surrounds a rod amplifier 104 to amplify incoming laser light using a light pump source 106. Immediately surrounding the rod amplifier 104 is a flow tube 110 having an inlet 112 and outlet 114, with fluid tight seals 116 being positioned to hold the rod amplifier 104. The flow tube can be filled with a recirculating fluid 118.

In operation, the light pump source 106 (which can be flashlamps, LEDs or laser diodes), directs light 121 having a first wavelength or range of wavelengths towards the rod amplifier 104. The first wavelength or range of wavelengths of light 121 is selected to be minimally absorbed by either the flow tube 110 or any contained recirculating fluid 118. In response to the directed light 121, the rod amplifier 104 amplifies power of an incoming laser beam 123 having a second wavelength or range of wavelengths. In effect, light from the light pump source 106 provides energy to a gain medium (in this case rod amplifier 104) to amplify power of the incoming laser light. The laser beam 123 passes longitudinally along the rod amplifier before exiting. Some small amount of non-longitudinal or transverse directed (with respect to the longitudinal axis of the rod amplifier 104) laser light 125 having the same second wavelength or range of wavelengths is incidentally created during this process. Commonly known as amplified spontaneous emission (ASE), the laser light 125 is absorbed by the recirculating fluid, with waste heat due to absorption being ultimately transferred to attached chiller or cooler systems.

FIG. 1B illustrates an alternative laser cooling system 100B similar to that discussed with respect to FIG. 1A. In this embodiment however, the flow tube 110 can be filled with a recirculating fluid 118 that does not directly absorb ASE laser light 125. Instead, shaped materials such as spheres, cubes, pyramids, hexagons, pentagons, heptagons, octagons, frits, lattices, overlapping structures, interlocking structures, or other macroscopic open pore light absorbing structures 119B, or regularly or irregularly shaped parts are doped with an absorber material and are used to absorb the ASE laser light 125. In some embodiments, shaped materials can include a solid matrix that incorporates or is formed from light absorbing material. Water or other fluid can flow around and through the absorbing structures or solid matrix 119B, removing waste heat. In some embodiments the structures can be immovably packed or held within a separate container system. In one embodiment, for example, a Nd:YAG rod amplifier could be surrounded with samarium doped glass balls ˜0.2-1 mm in diameter that are packed tightly around the rod. Gaps between the spheres serve as micro fluid flow pathways that allow for waste heat removal. Advantageously, the high surface area and small size of the spheres can yield a much higher thermal fracture limit versus standard absorbing flow tubes.

FIG. 1C illustrates an alternative laser cooling system 100C for a slab amplifier similar to that discussed with respect to the rod amplifier of FIGS. 1A and 1B but that does not require a separate flow tube. The system 100C includes an amplifier housing 102C having optional integral or attached light absorbing cladding 111C that at least partially surrounds a slab amplifier 104C. A flow cavity 110C is defined between the slab amplifier 104C and the light absorbing cladding 111C. An inlet 112C and outlet 114C are also defined to allow recirculating fluid 118C into and out of the cavity 110C. As previously described with respect to FIG. 1A, amplified spontaneous emission (ASE) laser light 125C is absorbed by the cladding.

FIG. 1D illustrates an alternative laser cooling system 100C for a slab amplifier similar to that discussed with respect to the rod amplifier of FIG. 1B. This embodiment does not require a separate flow tube and can instead use a flow cavity such as described with respect to FIG. 1C. The system 100D includes an amplifier housing 102D that at least partially surrounds a slab amplifier 104D. A flow cavity 110D is defined between the slab amplifier 104C and the amplifier housing 102D, and an inlet 112D and outlet 114D are also defined to allow recirculating fluid 118D into and out of the cavity 110D. The flow cavity can be filled with shaped material such as spheres, frits, lattice structure, or other macroscopic open pore light absorbing structures 119D that are doped with absorber material such as samarium or copper and are used to absorb the ASE laser light 125D. Water or other recirculating fluid 118D can flow around and through the absorbing structures 119B, removing waste heat. Generally the recirculating fluid should be index matched to the shaped material.

FIG. 1E illustrates an alternative solid state laser cooling system 100E for a slab amplifier similar to that discussed with respect to the slab amplifier of FIG. 1C. System 100E can operate as a liquid or solid state ASE absorbing system that can be used alone or in combination with liquid cooled systems such as discussed herein. In some operational modes, the system described in FIG. 1E can be operated without filling flow channels 110E, 112E and 114E with liquid. In other embodiments, the flow channels can be omitted from the system, to make amplifier housing 102E a continuous solid. Heat removal from the cladding is then achieved by face cooling of the amplifier housing 102E and amplifier slab 104E by a fluid such as water, silicone oil, or gases such as air, helium, or argon. Heat conducts from the cladding interface to the housing and from there to the face of the housing where it is cooled. The system 100E includes an amplifier housing 102E having optional integral or attached light absorbing cladding 111E that fully surrounds a slab amplifier 104E. This cladding can include ASE absorbing materials such as described in this disclosure, including copper or samarium doped materials in the form of solid state materials like glasses or crystals. The cladding can also be a low reflectance black coating such as lampblack, Actar black, tungsten black, carbon velvet black, or pyrolytic graphite. This cladding material is adhered to the amplifier housing with conductive epoxy or solder to facilitate heatsinking. The slab amplifier 104E can be mounted in the housing by means of a potting compound or glue 117E. This potting compound or glue can be transmissive to the ASE signal and can be refractive index matched, as closely as possible, to the amplifier slab 104E and the cladding to minimize reflections from the interfaces. The potting compound or glue can also be compliant to allow expansion and temperature mismatch between the slab and cladding to survive. Examples of useful potting compounds include optical cements such as Norland optical cement or transparent urethanes developed for this purpose. In those embodiments that use flowing liquid as a coolant, a flow cavity 110E is defined within the amplifier housing 102E to facilitate removal of heat. An inlet 112E and outlet 114E are also defined to allow recirculating fluid 118E into and out of the cavity 110E. As previously described with respect to FIG. 1C, amplified spontaneous emission (ASE) laser light 125E is absorbed by cladding.

In the described or other embodiments, a gain medium for a laser amplifier can be based on Neodymium, Ytterbium, or Erbium doped rods or slabs of materials such as Y₃AL₅O₁₂ (YAG), YLiF₄ (YLF), YVO₄, glass, GdVO₄, Gd₃Ga₅O₁₂ (GGG), KGd(WO₄)₂ (KGW), YAlO₃ (YALO), YAlO₃ (YAP), LaSc₃(BO₃)₄ (LSB), Sr5(PO₄)₃F (S-FAP), or Lu₂O₃, Y₂O₃.

In the described or other embodiments, narrow wavelength light absorbing and recirculating fluids or structures can include light absorbing salts such samarium nitrate or samarium chloride. Samarium salts have a narrow absorption in the 1-micron regime and still allow transmission in common light pump source wavelengths. Samarium salts are generally soluble in aqueous coolants such as water, can be put into solution or embedded in glass or nanoparticles. Alternatively, quantum dots suspended in a colloidal solution can be used as a light absorber. For example, silicon quantum dots can be tuned across the visible spectrum. With a change in materials to germanium or cadmium telluride, infrared narrow bandwidth absorption can be supported. As an alternative, dyes or other organic materials in solution or colloidal suspension can be used.

In the described or other embodiments, recirculating fluid able to hold salts in solution or remove waste heat can include water, water and anticorrosives such as Optishield®, ethylene or propylene glycol, alcohols, Fluorinert® or similar fluorine based cooling fluids, and siloxanes (silicone oils)). In yet another alternative, non-aqueous fluids or ionic fluids can be used as a recirculating coolant fluid.

In one embodiment, thulium doped materials such as Y₃AL₅O₁₂ (YAG), YLiF₄ (YLF), YVO₄, glass, GdVO₄, Gd3Ga5O₁₂ (GGG), KGd(WO₄)₂ (KGW), YAlO₃ (YALO), YAlO₃ (YAP), LaSc₃(BO₃)₄ (LSB), Sr₅(PO₄)₃F (S-FAP), or Lu₂O₃, Y₂O₃ which emit in the 2 micron spectral regime, praseodymium doped fluids (which can absorb at 2 microns but transmit in the 800 nm regime where they are typically diode pumped). For transition metal lasers like Ti:sapphire and Cr:LiSAF which absorb in the visible (400-700 nm) and lase in the NIR (700-1100), copper based salts like copper sulfate, copper nitrate, copper chloride can be used.

The embodiments discussed with respect to FIGS. 1A, 1B, 1C, and 1D allow power scaling of laser amplifiers significantly beyond the limits defined by the thermal fracture or damage of solid-state absorbing materials used for the edge cladding or flow tubes. The thermal power is instead absorbed directly into the recirculating fluid where the heat capacity of the fluid and flow rate can be used to engineer extremely high average power with little thermal load on the flow tube or housing. Since the flow tube and housing can be transparent to the pump and laser wavelength and do not absorb any significant power. The only heating of these components comes from the small temperature rise in the fluid coolant under average power operation. This eliminates the potential for catastrophic damage due to the edge cladding absorption and enables much higher average power capability of the amplifier. In effect, if a rod-based system has a repetition rate (average power) limit due to flow tube fracture, then the limit will no longer be that of the relatively fragile flow tube but rather the amplifier rod, enabling higher repetition rate capability of the system.

Typically, absorber material and laser amplifier will operate best if the absorption is optimized for the particular conditions of each laser amplifier and this invention makes tuning this system flexible and adaptable. Solid state absorbers must be fabricated and as such are subject to errors in doping, thickness, surface finish, etc. which can negatively impact the performance causing the edge cladding to run hot or cause parasitic loss in the amplifier. Typically, an absorber will absorb the inverse of the transverse gain (which can be >99% of the emission) and maintain an operating temperature which keeps the amplifier in peak performance. Since parasitic losses typically occur as laser amplifier temperature increases, it is best to keep temperature low. By changing the concentration of the absorber and flow rate of the coolant, the light absorption can be distributed across the flow channel, with absorption set to be just strong enough to inhibit parasitic lasing while removing the thermal load needed to keep the surface temperature of the amplifier near room temperature.

It should be noted that the physical hardware of the amplifier need not be changed to take advantage of this invention. For example, conventional and commonly available flow tubes having light absorbing dopants to absorb laser light and transmit pump light can still be used. Using the described light absorbing fluid or structures ensures that ASE or other laser radiation is absorbed before contacting the flow tube.

In some embodiments, use of an edge cladding or ASE light absorbing fluid that can transmit the pump light is not required. For example, amplifier rods can receive pump light along the laser beam entrance or exit surfaces, or slab amplifiers can be pumped through a large extraction face. Since the pump light does not need to be transmitted through the recirculating light absorbing fluid, use of a larger variety of light absorbing salts is supported. For example, copper or iron salt based coolants that absorb efficiently between 700 and 1200 nm (common in widely available laser materials) can be used. Other absorbing materials can include titanium doped Al₂O₃ (Ti:sapphire), Chromium doped LiSrAlF₆ (Cr:LiSAF), ytterbium doped materials, and neodymium doped materials. Ethanol can be used to absorb 1.5 micron laser emission of erbium based laser amplifiers.

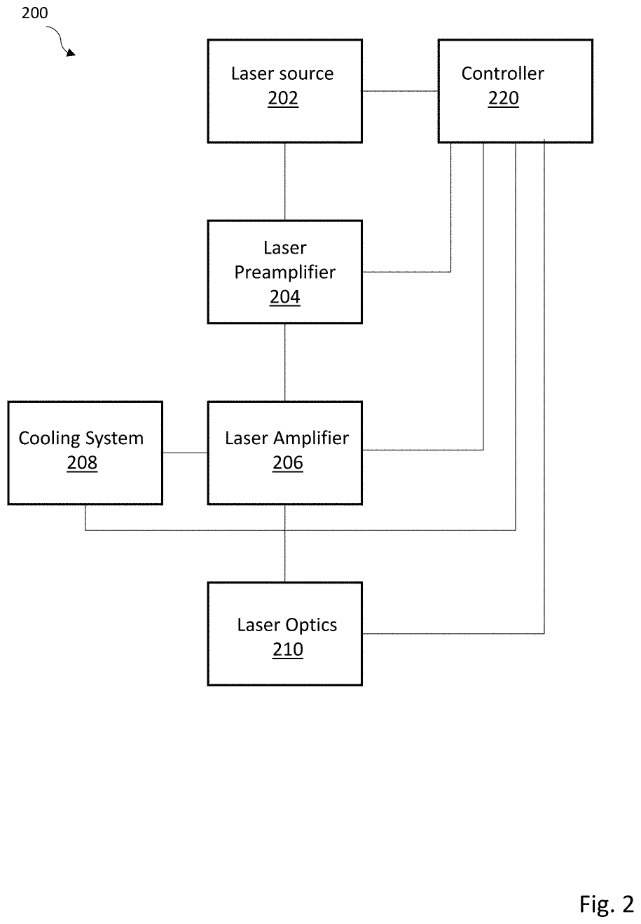

FIG. 2 illustrates one embodiment of a laser system 200 that supports the embodiments discussed with respect to FIGS. 1A, 1B, 1C, and 1D. FIG. 2 illustrates a laser source 202 directing light through an optional laser preamplifier 204 to a laser amplifier 206. The laser amplifier 206 is connected to a cooling system 208, and amplified light can be transmitted for final shaping and guiding by laser optics 210. The controller 220 and any included processors can be connected to variety of sensors, actuators, heating or cooling systems, monitors, or other external controllers as needed to coordinate operation. A wide range of sensors, including imagers, light intensity monitors, thermal, pressure, or gas sensors can be used to provide information used in control or monitoring. The controller 220 can be a single central controller, or alternatively, can include one or more independent control systems. The controller 220 can be provided with an interface to allow input of instructions. Use of a wide range of sensors allows various feedback control mechanisms that improve quality, manufacturing throughput, and energy efficiency.

In some embodiments, the laser source 202 of FIG. 2 can be constructed as a continuous or pulsed laser. In other embodiments the laser source 202 includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (all gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO₄) laser, Neodymium doped yttrium calcium oxoborate Nd:YCa₄O(BO₃)³ or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride (Ce:LiSAF, Ce:LiCAF), Promethium 147 doped phosphate glass (147 Pm⁺³:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

In some embodiments, various laser pre-amplifiers 204 are optionally used to provide high gain to the laser signal, while optical modulators and isolators can be distributed throughout the system to reduce or avoid optical damage, improve signal contrast, and prevent damage to lower energy portions of the system 200. Optical modulators and isolators can include, but are not limited to Pockels cells, Faraday rotators, Faraday isolators, acousto-optic reflectors, or volume Bragg gratings. Laser pre-amplifier 204 could be diode pumped or flash lamp pumped pre-amplifiers and configured in single and/or multi-pass or cavity type architectures. As will be appreciated, the term laser pre-amplifier here is used to designate amplifiers which are not limited thermally (i.e. they are smaller) versus laser amplifiers 206 (larger). As compared to laser-pre-amplifiers, laser amplifiers will typically be positioned to be one of the final units in a laser system 200 and will be most likely susceptible to thermal damage, including but not limited to thermal fracture or excessive thermal lensing.

Laser pre-amplifiers 204 can include single pass laser pre-amplifiers usable in systems not overly concerned with energy efficiency. For more energy efficient systems, multipass pre-amplifiers can be configured to extract much of the energy from each laser pre-amplifier 204 before going to the next stage. The number of laser pre-amplifiers needed for a particular system is defined by system requirements and the stored energy/gain available in each amplifier module. Multipass pre-amplification can be accomplished through angular multiplexing or polarization switching (e.g. using waveplates or Faraday rotators).

Alternatively, laser pre-amplifiers 204 can include cavity structures with a regenerative amplifier type configuration. While such cavity structures can limit the maximum pulse length due to typical mechanical considerations (length of cavity), in some embodiments “White cell” cavities can be used. A White cell is a multipass cavity architecture in which a small angular deviation is added to each pass. By providing an entrance and exit pathway, such a cavity can be designed to have extremely large number of passes between entrance and exit allowing for large gain and efficient use of the amplifier. One example of a White cell would be a confocal cavity with beams injected slightly off axis and mirrors tilted such that the reflections create a ring pattern on the mirror after many passes. By adjusting the injection and mirror angles the number of passes can be changed.

Laser amplifier 206 are also used to provide enough stored energy to meet system energy requirements, while supporting sufficient thermal management to enable operation at system required repetition rate whether they are diode or flashlamp pumped.

Laser amplifier 206 can be configured in single and/or multi-pass or cavity type architectures. Similar to laser pre-amplifiers, laser amplifier 206 can include single pass amplifiers usable in systems not overly concerned with energy efficiency. For more energy efficient systems, multipass laser amplifiers can be configured to extract much of the energy from each amplifier before going to the next stage. The number of laser amplifiers needed for a particular system is defined by system requirements and the stored energy/gain available in each amplifier module. Multipass laser amplification can be accomplished through angular multiplexing, or polarization switching (using e.g. waveplates or Faraday rotators).

Alternatively, laser amplifier 206 can include cavity structures with a regenerative amplifier type configuration. As discussed with respect to laser pre-amplifiers 204, amplifiers 206 can be used for power amplification.

In some embodiments, the cooling systems 208 can include passive or active fluid pumping systems. Sensors can be used by controller 220 to determine light transmission or laser light absorption characteristics. In some embodiments, waste heat can be used to increase temperature of connected components.

As will be appreciated, laser flux and energy can be scaled in this architecture by adding more pre-amplifiers and amplifiers with appropriate thermal management and optical isolation. Adjustments to heat removal characteristics of the cooling system are possible, with increase in pump rate or changing cooling efficiency being used to adjust performance.

The laser beam can be shaped by a great variety of laser optics 210 to combine, focus, diverge, reflect, refract, homogenize, adjust intensity, adjust frequency, or otherwise shape and direct one or more laser beams. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

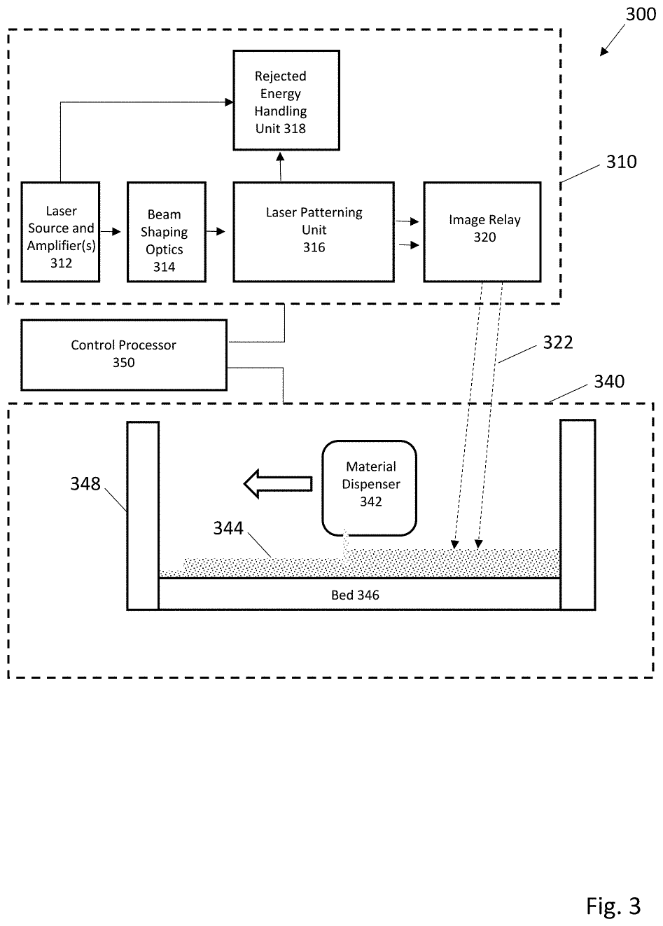

In another embodiment illustrated with respect to FIG. 3, amplifier architectures illustrated with respect to FIGS. 1A-D and system 200 of FIG. 2 can form a component of an additive manufacturing method and system 300. As seen in FIG. 3, a laser source and amplifier(s) 312 can include cooled laser amplifiers and other components such as previously describe. Advantageously, use of laser amplifiers such as described with respect to FIGS. 1A-D can allow for higher energy, faster additive manufacturing, and better system efficiency and throughput. Traditional additive manufacturing systems with existing flow tube amplifier systems can benefit by simple replacement of recirculating cooling fluid containing ASE absorbing salts or other suitable absorbing structures.

As illustrated in FIG. 3, the additive manufacturing system 300 uses lasers able to provide one or two dimensional directed energy as part of a laser patterning system 310. In some embodiments, one dimensional patterning can be directed as linear or curved strips, as rastered lines, as spiral lines, or in any other suitable form. Two dimensional patterning can include separated or overlapping tiles, or images with variations in laser intensity. Two dimensional image patterns having non-square boundaries can be used, overlapping or interpenetrating images can be used, and images can be provided by two or more energy patterning systems. The laser patterning system 310 uses laser source and amplifier(s) 312 to direct one or more continuous or intermittent energy beam(s) toward beam shaping optics 314. After shaping, if necessary, the beam is patterned by a laser patterning unit 316, with generally some energy being directed to a rejected energy handling unit 318. Patterned energy is relayed by image relay 320 toward an article processing unit 340, in one embodiment as a two-dimensional image 322 focused near a bed 346. The bed 346 (with optional walls 348) can form a chamber containing material 344 (e.g. a metal powder) dispensed by material dispenser 342. Patterned energy, directed by the image relay 320, can melt, fuse, sinter, amalgamate, change crystal structure, influence stress patterns, or otherwise chemically or physically modify the dispensed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

Article processing unit 340 can include a walled chamber 348 and bed 344 (collectively defining a build chamber), and a material dispenser 342 for distributing material. The material dispenser 342 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF6, CH₄, CO, N₂O, C₂H₂, C₂H₄, C₂H₆, C₃H₆, C₃H₈, i-C₄H₁₀, C₄H₁₀, 1-C₄H₈, cic-2,C₄H₇, 1,3-C₄H₆, 1,2-C₄H₆, C₅H₁₂, n-C₅H₁₂, i-C5H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

In certain embodiments, a plurality of article processing units or build chambers, each having a build platform to hold a powder bed, can be used in conjunction with multiple optical-mechanical assemblies arranged to receive and direct the one or more incident energy beams into the build chambers. Multiple chambers allow for concurrent printing of one or more print jobs inside one or more build chambers. In other embodiments, a removable chamber sidewall can simplify removal of printed objects from build chambers, allowing quick exchanges of powdered materials. The chamber can also be equipped with an adjustable process temperature controls. In still other embodiments, a build chamber can be configured as a removable printer cartridge positionable near laser optics. In some embodiments a removable printer cartridge can include powder or support detachable connections to a powder supply. After manufacture of an item, a removable printer cartridge can be removed and replaced with a fresh printer cartridge.

In another embodiment, one or more article processing units or build chambers can have a build chamber that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or build chambers with a build platform that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having an article processing units or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

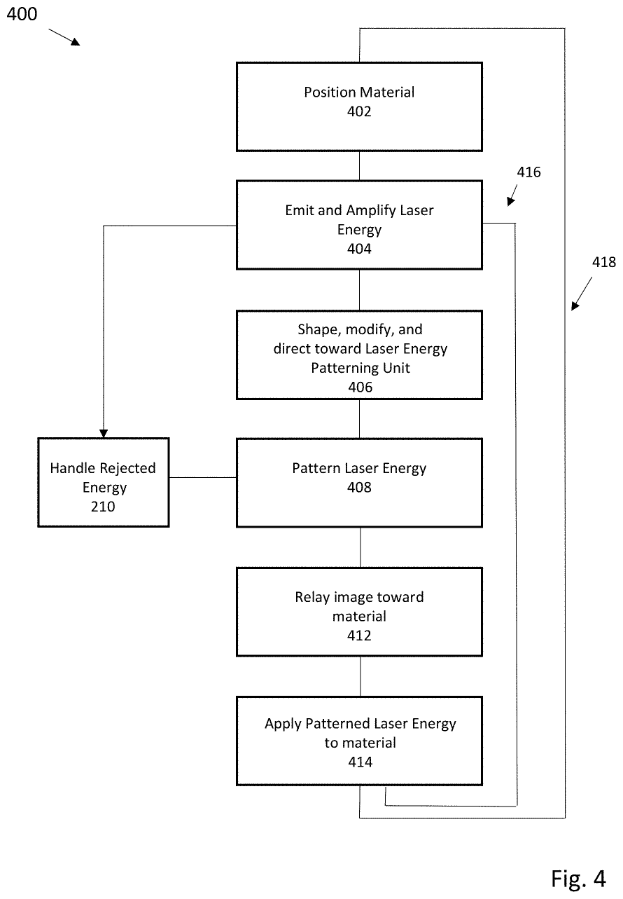

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 402, material is positioned in a bed, chamber, or other suitable support. The material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

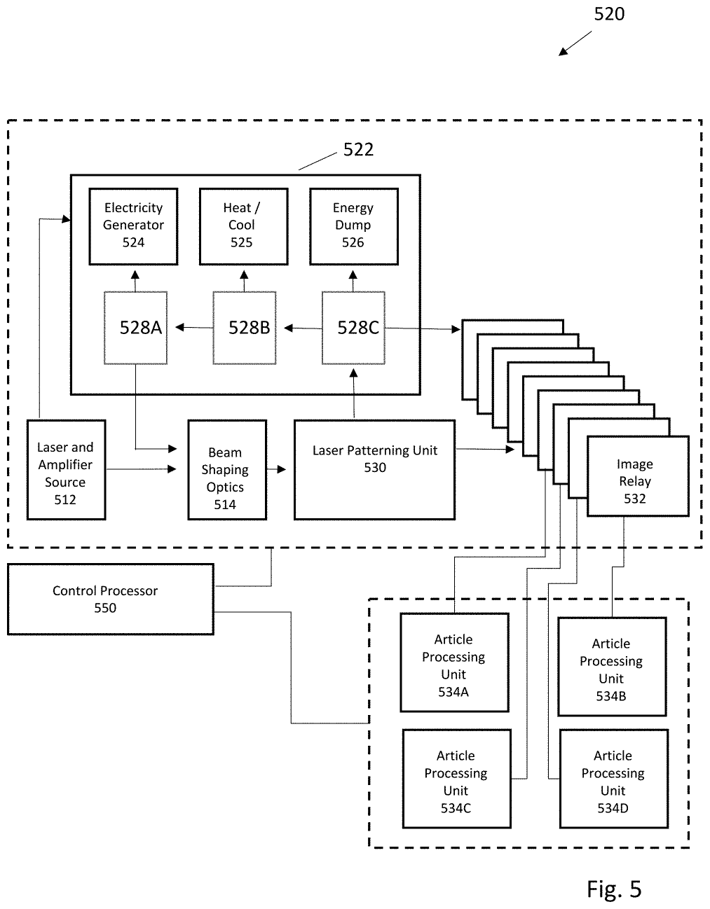

FIG. 5 is one embodiment of an additive manufacturing system that includes a switchyard system enabling reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 112 can be directed into one or more of an electricity generator 524, a heat/cool thermal management system 525, or an energy dump 526. Additionally, relays 528A, 528B, and 52C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units. 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A manufacturing method, comprising:
generating laser light at a first wavelength or range of wavelengths;
optically pumping a laser amplifier having a gain medium that amplifies light at a second wavelength or range of wavelengths in response to receiving the generated laser light;
cooling the gain medium with a coolant fluid able to absorb the second wavelength or range of wavelengths;
directing the generated and amplified laser light toward an article processing unit.

2. The manufacturing method of claim 1, wherein the gain medium is at least one of a rod amplifier and a slab amplifier.

3. The manufacturing method of claim 1, wherein the gain medium is at least one of a Nd:YAG rod and a Nd:YLF rod.

4. The manufacturing method of claim 1, wherein the coolant fluid comprises an aqueous salt solution.

5. The manufacturing method of claim 1, wherein the coolant fluid comprises an aqueous salt solution with at least one of samarium chloride, samarium nitrate, samarium sulfate, copper nitrate, copper sulfate, or copper chloride.

6. The manufacturing method of claim 1, wherein heat from the coolant fluid is processed by a rejected energy handling unit.

7. The manufacturing method of claim 1, wherein directed amplified laser light is patterned as a two dimensional image.

8. The manufacturing method of claim 1, wherein directed amplified laser light is patterned using a light valve.

9. The manufacturing method of claim 1, wherein the article processing unit comprises an additive manufacturing build chamber.

10. The manufacturing method of claim 1, wherein the article processing unit comprises an additive manufacturing build chamber that holds at least one of a metal, ceramic, plastic, glass metallic hybrid, ceramic hybrid, plastic hybrid, or glass hybrid material that can receive directed amplified laser light.

11. A manufacturing method using a laser amplifier, comprising:
providing a light pump source for the laser amplifier that can generate light at a first wavelength or range of wavelengths;
optically pumping the laser amplifier using a gain medium that amplifies light at a second wavelength or range of wavelengths in response to receiving generated light from the light pump source;
providing a housing to at least partially surround the gain medium and hold a solid matrix that is able to absorb the second wavelength or range of wavelengths;
cooling the laser amplifier with a coolant fluid; and
directing the generated and amplified laser light toward an article processing unit.

12. The manufacturing method using a laser amplifier of claim 11, wherein the solid matrix defines a lattice structure doped with samarium or copper.

13. The laser amplifier of claim 11, wherein the solid matrix comprises at least one of a lattice structure doped with samarium or copper or a bed of pebble shaped material doped with samarium or copper.

14. A manufacturing system, comprising:
a laser source generating light at a first wavelength or range of wavelengths;
a laser amplifier having a gain medium that amplifies light at a second wavelength or range of wavelengths in response to receiving the generated laser light, with the laser amplifier including a gain medium cooled with a coolant fluid able to absorb the second wavelength or range of wavelengths;
a laser patterning unit positioned to receive and pattern the amplified light; and
an image relay positioned to receive the patterned and amplified light, directing it toward an article processing unit.

15. The manufacturing system of claim 14, wherein heat from the coolant fluid is processed by a rejected energy handling unit.

16. The manufacturing system of claim 14, wherein amplified laser light is spatially patterned as a two dimensional image.

17. The manufacturing system of claim 14, wherein amplified laser light is patterned using a light valve.

18. The manufacturing system of claim 14, wherein the article processing unit comprises an additive manufacturing build chamber.

19. The manufacturing system of claim 14, wherein the article processing unit comprises an additive manufacturing build chamber that holds at least one of a metal, ceramic, plastic, glass metallic hybrid, ceramic hybrid, plastic hybrid, or glass hybrid material that can receive amplified and patterned laser light.
